(19) United States
(12) Patent Application Publication
(10) Pub. No.: US 2008/0136155 A1
(43) Pub. Date: Jun. 12, 2008

(54) Rollover protection system for motor vehicles with a sensor-controlled actively deployable rotary bar

(75) Inventors: Mirko Janisch, Lohmar (DE); Josef Lang, Budapest (HU); Reinhard Nowack, Drolshagen (DE)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: Automotive Group ISE Innomotive Systems Europe GmbH, Bergneustadt (DE)

(21) Appl. No.: 11/999,152

(22) Filed: Dec. 4, 2007

(30) Foreign Application Priority Data
Dec. 4, 2006 (DE) 102006057029.4-22

(51) Int. Cl. B60R 21/13

(52) U.S. Cl. 280/756

(57) ABSTRACT

The invention is based on a known rollover protection system for motor vehicles having two seat-related rotary bars permanently articulated to the vehicle body, said rotary bars each being fixable in the stored resting position by means of a holding device, and being rotatable into a locked support position by means of a sensor-controlled drive. To compactly design the system with several functional parts, the invention provides a toggle lever arrangement to convert the movement of the drive into a rotary bar movement, said arrangement being articulated to the drive and the rotary bar such that it is folded at least partially within the area framed by the rotary bar when the rotary bar is in its resting position.

### BACKGROUND OF THE INVENTION

1. Field of the Invention

The invention relates to a rollover protection system for motor vehicles having two seat-related rotary bars permanently articulated to the vehicle body, said rotary bars each being fixable in the stored resting position by means of a holding device, and being rotatable into a locked support position by means of a sensor-controlled drive.

2. Description of Related Art

Such rollover protection systems are for protecting passengers in motor vehicles without a protective roof, typically in open convertibles or roadsters, by creating a survival area for the passengers in a rollover since the vehicle rolls over the deployed rollover body.

It is known to provide a roll bar that extends the entire width of the motor vehicle and is designed as part of the body. In this solution, the increased air resistance and arising vehicle noise is perceived as disadvantageous apart from the impairment of the vehicle's appearance.

It is also known to assign each vehicle seat a non-height-adjustable roll bar permanently installed in the passenger compartment, i.e. a rigid, U-shaped roll bar. This solution is typically used for roadsters to underscore the sporty appearance.

Widespread in convertibles are design solutions where the rollover body is normally retracted and, in case of a hazard, i.e. in case of a pending rollover, the rollover body quickly deploys into a protective position to prevent the passengers from being crushed by the rolling vehicle.

These so-called “active” rollover protection systems frequently have a U-shaped roll bar guided in a guide body permanently attached to the vehicle or a rollover body formed out of a shaped body, and the guide body is affixed in a cassette housing that has side parts and a floor part. This roll bar or rollover body is normally held by a holding device in a bottom, resting position against the pretension of at least one drive pressure spring, and in a rollover, the roll bar can be moved into a top, protective position in response to a sensor by means of the spring force of the drive pressure spring when the holding device releases, and a locking device, the retraction lock, having engaging teeth prevents the rollover bar from being pressed back inside. Each motor vehicle seat is typically assigned one cassette. Such a cassette construction of an active rollover protection system with a U-shaped roll bar is for example disclosed in DE 100 40 642 C1.

In addition to cassette designs, active rollover protection systems are also known that use a rear wall principle and have a rear wall assembly as for example described in DE 103 44 446 B3. Such a rollover protection system typically possesses a frame construction having a shaped cross member permanently affixed to the body and extending across the inner width of the vehicle between the rear passenger compartment and trunk, said cross member having inter alia guiding means for two adjacent, U-shaped roll bars or a roll bar extending across the width of the vehicle.

Both the cassette designs and cross member designs have been introduced to the market and are used in many embodiments adapted to the respective vehicle type. Vehicles are also known in which a roll bar extending nearly across the width of the vehicle can be swung up from a horizontal resting position into a vertical protective position on an axis (the so-called Y-axis) perpendicular to the direction of the vehicle. A perceived disadvantage is that the roll bar moves toward the heads of the vehicle passengers when it swings up. In addition, it is not easy to integrate the swivel bearings and the drive mechanisms in the vehicle design.

In addition, an active rollover protection design is known that has two roll bars that are adjacent viewed perpendicular to the vehicle, said roll bars being pivotable on a swivel axis within an essentially perpendicular transverse plane of the vehicle, said swivel axis running along the length of the vehicle, the so-called X-direction, and the roll bars are swingable in a hazard out of a lowered resting position into an upwardly-directed support position (and then back). These active, swingable roll bars are termed rotary bars below, although the term swivel bar is also known.

Such a rollover protection design with rotary bars is for example disclosed in DE 39 25 515 C1 and DE 40 17 778 A1.

The invention is based on such a rollover protection system with rotary bars. It requires in principle less installation space and can be easily incorporated in vehicle designs and reduces the risk of injury to the vehicle passengers when it quickly swings out since the rotary bars swing out of a pocket-like recess past the passengers' heads and do not swing toward them.

In the known case, the rotary bars have an essentially U-shaped basic design with an arced rollover head and two linear legs fastened thereto whose free ends are connected to a crossbar that forms a closed frame together with the rotary bar and has a flush extension. Extending below the crossbar and its extension is an integrated sheet metal part on which the bearing sleeves of the bar swivel bearing is formed as well as in principle an articulation for the rotary bar drive.

The drive mechanism for the rotary bar comprises two drives that drive linearly downward, a spring drive for fast crash deployment, and a hydraulic drive for arbitrary deployment (comfort drive) whose one end is commonly articulated to the roll bar frame at a lateral distance from the swivel axis, and its other end abuts an integrated base frame that also bears the holder in a resting position and the locking mechanism in a deployed state (retraction lock).

The drives and hence the base frame essentially extend linearly downward so that a relatively large vertical installation space is also required to accommodate the necessary deployment stroke, said installation space not being available in every motor vehicle.

Other rotary bars are known from DE 41 08 878 A1 as well as AT 43 52 U1. The first cited document discloses for example a seat-related roll bar extending in a translatory direction having a toggle lever arrangement for a rotary drive. The second cited document discloses inter alia a rotatable rollover protection system having a translatory drive that can be provided with a toggle lever arrangement.

### BRIEF SUMMARY OF THE INVENTION

The invention is based on the problem of designing the rotary bar and its deployment mechanism of the initially-described rollover protection system to achieve a very compact design with a few components, and in particular requiring little vertical installation space.

This problem is solved with a rollover protection system for motor vehicles having two seat-related rotary bars permanently articulated to the vehicle body, said rotary bars each being fixable in the stored resting position by means of a holding device, and being rotatable into a locked support position by means of a sensor-controlled drive according to the invention in that a toggle lever arrangement is provided to convert the movement of the drive into a rotary bar movement, said arrangement being articulated to the drive and the rotary bar, and the toggle lever arrangement being coupled to the drive and rotary bar such that it is folded at least partially within the area framed by the rotary bar when the rotary bar is in its resting position.

By means of the measure according to the invention, a rollover protection system can be created with rotary bars that very advantageously permits a compact design and therefore only requires a very small installation space both in terms of depth and height. It is therefore also advantageously suitable for retrofitting existing convertible vehicles or for installation in small convertibles. A particularly compact design is achieved in that the toggle lever arrangement is folded when the rotary bar is in resting position and lies at least partially and preferably mostly within the area framed by the rotary bar.

In another embodiment of the invention, the toggle lever arrangement can assume another essential function of a rollover protection system when it is coupled to the drive and rotary bar such that it forms a support element for deflecting the force arising in a rollover when the rotary bar is deployed.

Additional embodiments and developments of the invention are characterized in the subclaims and can also be found in the description of the figures.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. The invention will be further described with reference to the different views and states of the exemplary embodiment in the drawings.

The drawings show:

FIG. 1 is a schematic front view of the rotary bar designed according to the invention with toggle lever deployment and a pyrotechnic drive in stored resting position,

FIG. 2 is an isometric view of the rotary bar from FIG. 1,

FIG. 3 is a front view of the rotary bar from FIG. 1 that is completely deployed,

FIG. 4 is the deployed rotary bar from FIG. 3 in a rearward front view, and

FIG. 5 is an isometric view of the deployed rotary bar from FIG. 3.

### DETAILED DESCRIPTION OF THE INVENTION

The figures show an actively deployable rotary bar 1 for a rollover protection system for motor vehicles in a preferred embodiment of the associated deployment drive in the form of a pyrotechnic piston/cylinder unit 2 in conjunction with a toggle lever linkage 3 to convert the translatory movement of the piston of unit 2 into a rotary movement.

Two other necessary components of the rollover protection system are also shown, the holding device or holder (that fixes the position of the stored rotary bar) and the retraction lock (that locks the deployed bar). All the other components are not shown to provide a better view. They correspond to known embodiments.

Typically, two seat-related rotary bars are in a vehicle that are side-by-side viewed in a transverse direction of the vehicle and are deployably attached to a swivel axis viewed in the longitudinal direction of the vehicle. The two rotary bars can however be articulated on an axis transverse to the direction of the vehicle in a side wall of the vehicle.

As shown in particular by the isometric view, the rotary bar 1 is designed as a narrow-strip frame having an arced frame section 1 a at the head side, and having at the base side a rectangular frame section 1 b open at the top with rounded corners. At one transition between both sections, an eye-like projection 1c is created having a bearing sleeve 4 symbolically represented as a borehole to receive the rotary axis of the bar (not shown) permanently affixed to the body. At the other transition between the two sections, a narrow-strip diagonal brace 1d is created whose other end is affixed to the diagonally opposing corner of the rectangular section. Both transitions are connected by a narrow-strip cross-brace 1 e that possesses a top, concave section and unites with the diagonal brace 1 d.

The drive for rotating the rotary bar, i.e., the pyrotechnic piston/cylinder unit 2, consists of a cylinder 2 a containing a pyrotechnic propellant (also termed a charge) at the floor, above which it receives an axially displacable piston with a piston rod 2 b. A toggle lever linkage 3 is provided to convert the translatory movement of the piston rod into the rotary movement of the bar 1. A toggle lever of course consists of two single-arm levers (a support lever 3 b and a swivel lever 3 c in this instance) connected by a joint, the knee (at the pivot point 3 a in this instance), said levers being movably mounted in a joint at their other ends.

The free end of the swivel lever 3c is centrally articulated to the diagonal brace 1 d at the pivot point 3 d, and the free end of the support lever 3 b is articulated at the pivot point 3e to a fastening plate 5 permanently fixed to the vehicle body. So that the rotary bar does not extend too deeply at these pivot points, the elements to be connected are mortised to each other.

The floor-side end of the cylinder 2 a of the pyrotechnic drive unit 2 is articulated to the fastening plate 5 with a clip 2 d at the pivot point 5 a.

The free end of the piston rod 2 b is rotatably mortised to the support lever 3 b at the pivot point 2 c in the area of the knee 3 a. Below the cross-brace 1 e, a hook-shaped rotary pawl 6 is articulated to a bearing block of the bar frame, said rotary pawl locking the deployed rotary bar as will be explained below. This rotary pawl 6 is pretensioned by means of a leg spring 7 in the locking direction.

The rotary bar according to the invention operates as follows:

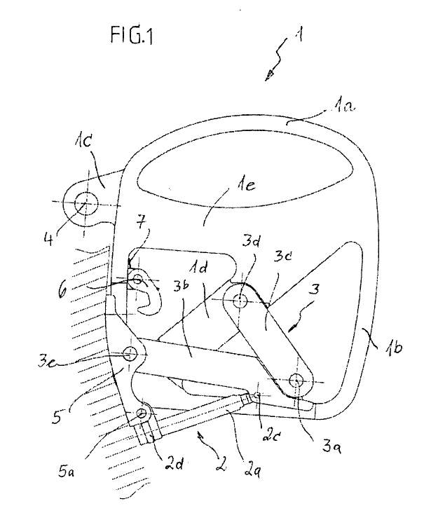

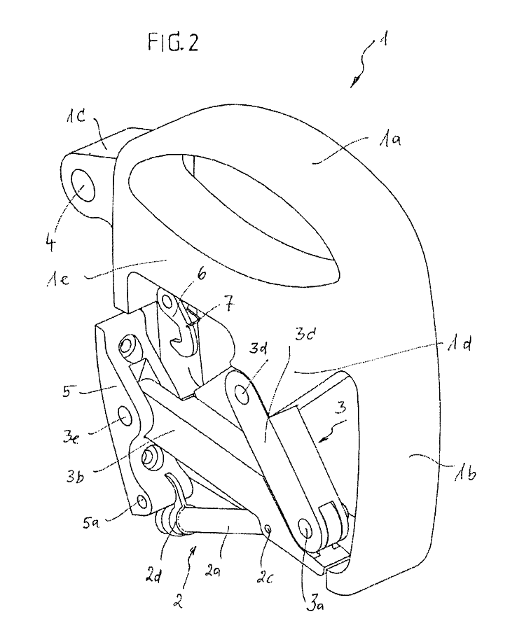

In the stored, basic state of the rotary bar (FIGS. 1 and 2), the toggle lever linkage 3 is “folded,” and together with the piston/cylinder unit 2, essentially only covers the area assumed by the rotary bar so that the roll bar and its drive mechanism are constructed very compactly and only require a small amount of installation space, especially in the vertical direction.

Since the piston in the cylinder 2 a has a “tight” seat when resting due to a keyed fit and/or friction-locked connection, for example by means of corresponding piston rings or preferably by means of a locally limited connection, such as a groove-like crimping (stamping), beading, press adaptation, wedging, etc. the rotary bar is also thereby fixed in the resting position; the “tight” seat therefore represents the holding device with a release force greater than 300 N and less than 5000 N.

If the conventional sensors (not shown) recognize a pending rollover, the pyrotechnic propellant in the cylinder 2 a is ignited, and the piston ejects with its piston rod 2 b. Since the piston rod forcefully contacts the area of the knee 3 a, it unfolds the two single-arm levers from each other based on the toggle lever principle, i.e. the support lever 3 b and the swivel lever 3 c. The support lever 3b is deployed, and the concomitantly deployed and swung swinging lever 3 c simultaneously swings the roll bar 1 counterclockwise from the perspective in FIG. 1.

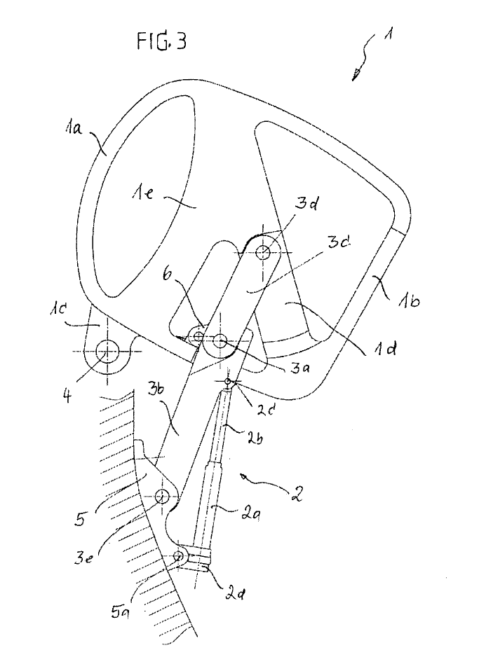

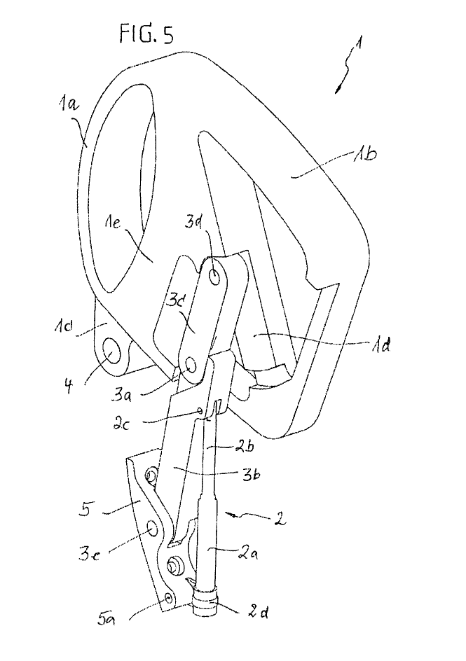

FIGS. 3, 4 and 5 show the rotary bar completely swung up in the protective position. The toggle lever is in a top dead center position, and the knee-side end of the swivel lever 3 c abuts a projection-like bevel on the knee-side end of the support lever 3 b.

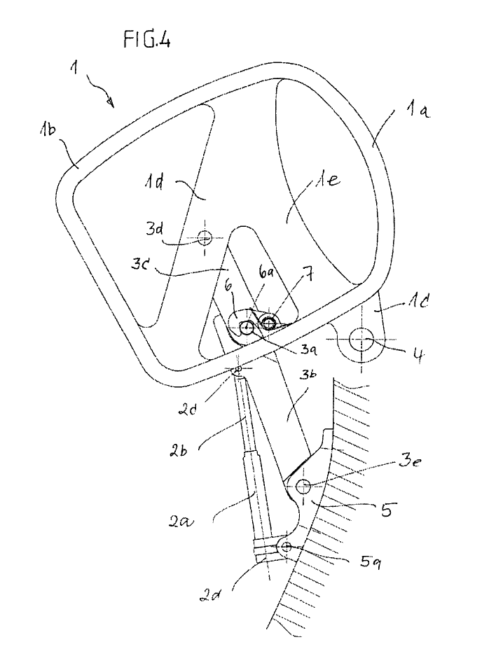

In this position, as is particularly illustrated by the rearward view in FIG. 4, the rotary pawl 6 with the shaft 6a held at the knee pivot point 3a lockingly engages and holds the toggle lever in an unfolded state. It forms the retraction lock together with the top dead center position and the support of the swivel lever.

The retraction lock and the holding device of the roll bar system do not require any additional installation space as can be seen in FIGS. 1-5, i.e., the portrayed construction also supports the compact design.

To provide additional or alternative support in a deployed state, a projecting stop can be attached to the support lever 3 b directly below the bar frame, said stop directly contacting the bar frame and additionally supporting it in a rollover.

In another embodiment of the invention, the pyrotechnic piston/cylinder unit 2 and the toggle lever linkage 3 can be coupled in another manner. It is conceivable to articulate the longer support lever 3 b at the central pivot point 3 d to the diagonal brace 1 d, and articulate the shorter swivel lever 3 c at pivot point 3 e to the fastening plate 5 permanently affixed to the body. The cylinder 2 a is then articulated via the clip 2 d to the central projection of the diagonal brace, and the piston rod 2 b is articulated at the pivot point 3 a of the knee.

The function of this embodiment corresponds to the described and portrayed embodiment.

Instead of the pyrotechnic drive, a spring drive can also be provided, for example a linearly deployable pressure helical spring or a spiral spring.

The roll bars are typically metal parts that are manufactured according to applicable methods, and the bar heads are typically surrounded with plastic foam.

### LIST OF REFERENCE NUMBERS

1 Rotary bar
1 a Arced frame section
1 b Rectangular frame section
1 c Eye-like projection
1 d Diagonal brace
1 e Cross brace
2 Pyrotechnic piston/cylinder unit
2 a Cylinder
2 b Piston rod
2 c Pivot point
2 d Clip
3 Toggle lever linkage
3 a Pivot point (knee) of the toggle lever
3 b Support lever
3 c Swivel lever
3 d, e Pivot points
4 Bearing sleeve
5 Fastening plate
5 a Pivot point
6 Rotary pawl
6 a Shaft
7 Leg spring

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A rollover protection system for a motor vehicle, comprising two seat-related rotary bars permanently articulated to a vehicle body, each rotary bar being fixable in a stored resting position by means of a holding device, and being rotatable into a locked support position by means of a sensor-controlled drive, characterized in that a toggle lever arrangement is provided to convert a movement of the drive into a rotary bar movement, said arrangement being articulated to the drive and the rotary bar, and the toggle lever arrangement being coupled to the drive and the rotary bar such that it is folded at least partially within an area framed by the rotary bar when the rotary bar is in the resting position.

2. The rollover protection system according to claim 1, wherein the toggle lever arrangement has a support lever and a swivel lever that are articulated to each other at a pivot point forming a knee, and one free end is permanently articulated to the vehicle and an other end is connected to the rotary bar.

3. The rollover protection system according to claim 2, wherein one end of the drive is articulated at the knee of the toggle lever arrangement, and another end of the drive is permanently articulated to the vehicle.

4. The rollover protection system according to claim 1, wherein the drive is designed as a translatory drive.

5. The rollover protection system according to claim 4, wherein the translatory drive is formed by a pyrotechnic piston/cylinder unit.

6. The rollover protection system according to claim 4, wherein the translatory drive is formed by a helical spring.

7. The rollover protection system according to claim 4, wherein the translatory drive is formed by a combination of a pyrotechnic piston/cylinder unit and a helical spring drive.

8. The rollover protection system according to claim 5, wherein a piston in the cylinder of the pyrotechnic piston/cylinder unit is held with a predefined retention force specified by the holding device.

9. The rollover protection system according to claim 1, wherein the drive is formed as a helical spring drive.

10. The rollover protection system according to claim 1, wherein the rotary bar has a narrow-strip frame, and the toggle lever arrangement is within the frame and can be stored folded when the rotary bar is in the resting position.

11. The rollover protection system according to claim 10, wherein the frame has a top, arced section and a bottom rectangular section, and a cross-brace is provided that connects transitions between the two sections, and a diagonal brace is provided that connects one of the transitions to a diagonally opposing corner of the rectangular section.

12. The rollover protection system according to claim 2, wherein the rotary bar has a narrow-strip frame, and the toggle lever arrangement is within the frame and can be stored folded when the rotary bar is in the resting position, and wherein the frame has a top, arced section and a bottom rectangular section, and a cross-brace is provided that connects transitions between the two sections, and a diagonal brace is provided that connects one of the transitions to a diagonally opposing corner of the rectangular section, and wherein the free end of the swivel lever is articulated to a center of the diagonal brace.

13. The rollover protection system according to claim 11, wherein an eyelike projection with a bearing sleeve for rotatably mounting the rotary bar is attached to one of the transitions between the two sections.

14. The rollover protection system according to claim 1, wherein the toggle lever arrangement is coupled to the drive and the rotary bar such that it forms a support element when unfolded to deflect force arising during a rollover when the rotary bar is deployed.

15. The rollover protection system according to claim 14, wherein the toggle lever arrangement is unfolded in a top dead center position.

16. The rollover protection system according to claim 14, wherein a lockable safety device is provided for a deployed state of the toggle lever arrangement with a first safety element attached to the rotary bar and a second safety element attached to the toggle lever arrangement.
